(19) United States
(12) Patent Application Publication
(10) Pub. No.: US 2018/0045908 A1
(43) Pub. Date: Feb. 15, 2018

(54) EASILY ASSEMBLED FILTER ADAPTOR ASSEMBLY

(71) Applicant: MICROVIEW TECHNOLOGY CORP., TAOYUAN CITY (TW)

(72) Inventor: Tzu-Shang HUANG, TAOYUAN CITY (TW)

(73) Assignee: MICROVIEW TECHNOLOGY CORP., TAOYUAN CITY (TW)

(21) Appl. No.: 15/264,952

(22) Filed: Sep. 14, 2016

(30) Foreign Application Priority Data
Aug. 12, 2016 (TW) 105125735

(51) Int. Cl. G02B 7/00

(52) U.S. Cl. CPC G02B 7/006

(57) ABSTRACT

An easily assembled filter adaptor assembly has a front mounting ring, a holding ring, a rear mounting ring, multiple intermediate rings, and at least one inner mounting ring, which are detachably connected with each other. Filters are selectively held between the front mounting ring, the holding ring, the intermediate rings, and the at least one inner mounting ring. The filter adaptor assembly has a simplified and compact structure. Accordingly, volume of the filter adaptor assembly can be reduced. Furthermore, numbers of the intermediate ring and the inner mounting ring can be increased or decreased so as to adjust numbers of the filters that can be assembled in the filter adaptor assembly. Accordingly, users have high flexibility in using the filter adaptor assembly

### BACKGROUND OF THE INVENTION

### 1. Field of the Invention

The present invention related to a filter adaptor assembly, especially to an easily assembled filter adaptor assembly for a user to easily increase or decrease numbers of filters according to the user's need.

### 2. Description of the Prior Art(s)

An optical filter, such as a UV (Ultraviolet) filter, a polarizing (PL) filter, a circular polarizing (CPL) filter, a neutral density (ND) filter, and the like is a camera accessory that is mounted in front of a lens of the camera. In addition to lens protection, the optical filter also selectively transmits light in a particular range of wavelengths, so as to form particular lighting effects on photos or videos.

A conventional filter adaptor assembly comprises multiple filters. Each of the filters is held in a mounting frame by a holding frame. The mounting frames are connected to each other via adapting frames. The adapting frame that is arranged at an end of the conventional filter adaptor assembly can be mounted to the lens of the camera via a positioning frame. By assembling or rotating the filters with different effects, the conventional filter adaptor assembly can form variable lighting effects.

However, although a plurality of filters can be assembled in the conventional filter adaptor assembly, the number of the filters in the conventional filter adaptor assembly is constant. Thus, arrangement of the filters is invariable and lacks flexibility. Moreover, each of the mounting frames that are used for mounting the filters has to be connected to the other mounting frame via the adapting frame. The conventional filter adaptor assembly is bulky and has complicated structure.

To overcome the shortcomings, the present invention provides an easily assembled filter adaptor assembly to mitigate or obviate the aforementioned problems.

### SUMMARY OF THE INVENTION

The main objective of the present invention is to provide an easily assembled filter adaptor assembly. The filter adaptor assembly has a front mounting ring, a holding ring, a rear mounting ring, multiple intermediate rings, and at least one inner mounting ring, which are detachably connected with each other. The holding ring is detachably mounted in the front mounting ring. The intermediate rings and the at least one inner mounting ring are alternately arranged between the front mounting ring and the rear mounting ring and are detachably connected to each other. The intermediate ring that is disposed next to the front mounting ring is detachably connected to the front mounting ring. The intermediate ring that is disposed next to the rear mounting ring is detachably connected to the rear mounting ring. Filters can be selectively held between the front mounting ring, the holding ring, the intermediate rings, and the at least one inner mounting ring.

The filter adaptor assembly has a simplified and compact structure. Accordingly, volume of the filter adaptor assembly can be reduced. Furthermore, numbers of the intermediate ring and the inner mounting ring can be increased or decreased so as to adjust numbers of the filters that can be assembled in the filter adaptor assembly. Accordingly, users can have high flexibility in using the filter adaptor assembly.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a preferred embodiment of an easily assembled filter adaptor assembly in accordance with the present invention;

FIG. 2 is an enlarged cross-sectional side view of the filter adaptor assembly in FIG. 1;

FIG. 3 is an exploded perspective view of the filter adaptor assembly in

FIG. 4 is an exploded cross-sectional side view of the filter adaptor assembly in FIG. 1; and

FIG. 5 is an enlarged cross-sectional side view of another preferred embodiment of an easily assembled filter adaptor assembly in accordance with the present invention.

### DETAILED DESCRIPTION OF THE PREFERRED EMBODIMENTS

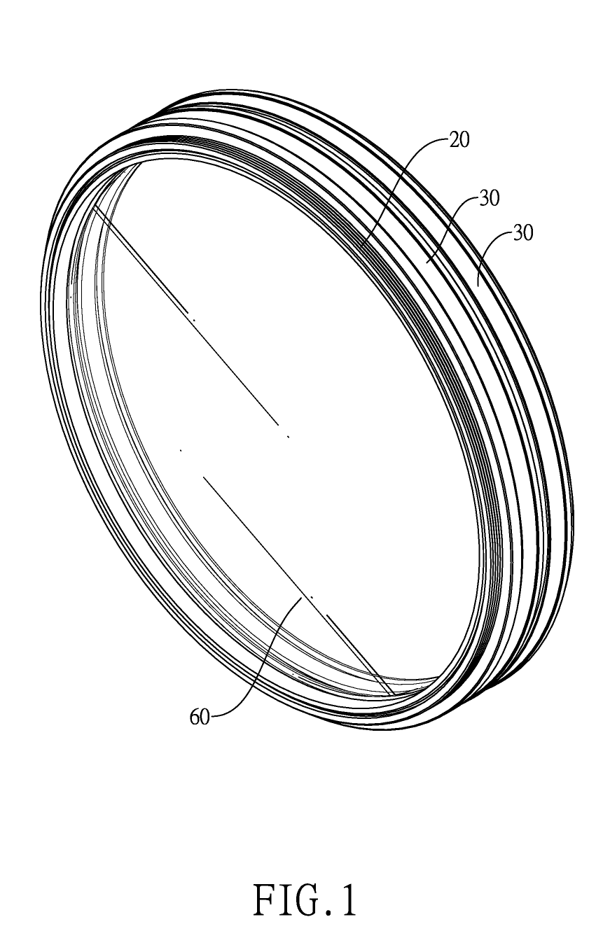

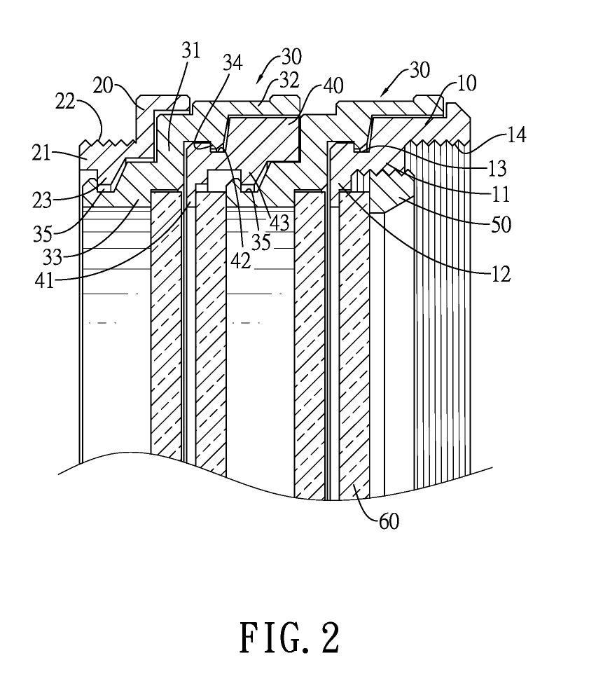

With reference to FIGS. 1 and 2, an easily assembled filter adaptor assembly in accordance with the present invention comprises a front mounting ring 10, a holding ring 50, a rear mounting ring 20, multiple intermediate rings 30, and at least one inner mounting ring 40.

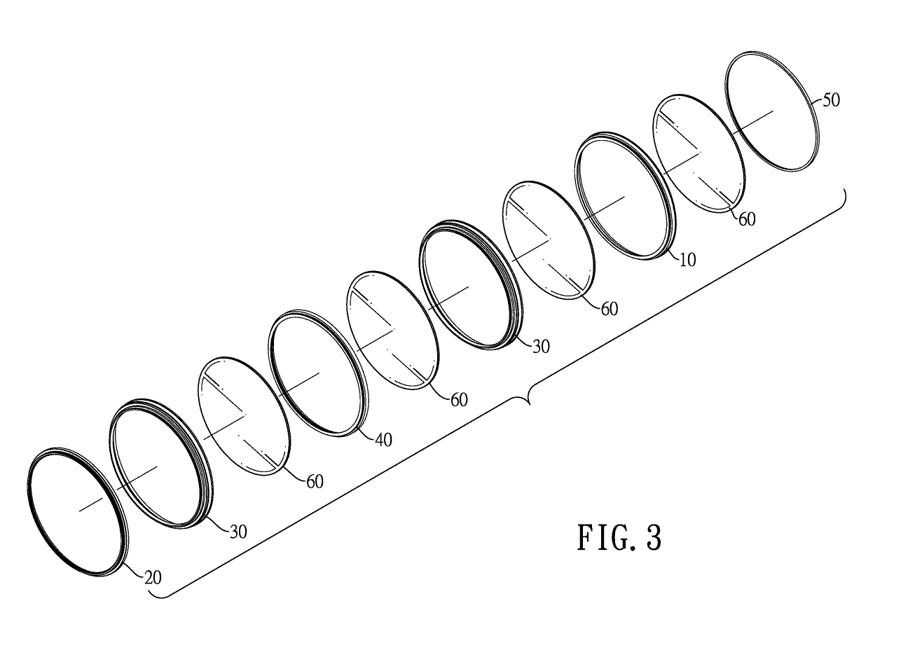

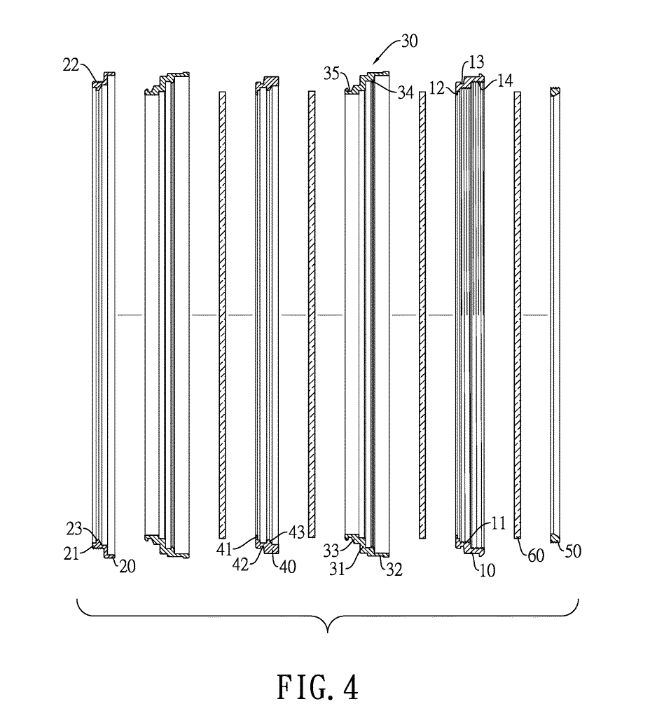

With further reference to FIGS. 3 and 4, the front mounting ring 10 has a rear end, a connecting ring portion 11, an inner sidewall, a limiting flange 12, and an inner thread 14. The connecting ring portion 11 axially protrudes from the rear end of the front mounting ring 10 and has a distal end edge. The inner sidewall of the front mounting ring 10 is defined inside and around the front mounting ring 10 and has a sub inner sidewall. The sub inner sidewall is defined inside and around the connecting ring portion 11. The limiting flange 12 radially protrudes from and is formed around the sub inner sidewall around the connecting ring portion 11 and is disposed adjacent to the distal end edge of the connecting ring portion 11. The inner thread 14 is formed around the inner sidewall of the front mounting ring 10. A dust-proof cap can be mounted to a front end of the front mounting ring 10 via the inner thread 14, so as to be put on the filter adaptor assembly.

The holding ring 50 is detachably mounted in the connecting ring portion 11 of the front mounting ring 10, so as to selectively hold a filter 60 between the holding ring 50 and the connecting ring portion 11 of the front mounting ring 10. Specifically, the holding ring 50 is connected to the connecting ring portion 11 of the front mounting ring 10 via the inner thread 14.

The rear mounting ring 20 is disposed at a rear of the front mounting ring 10 and is spaced apart from the front mounting ring 10. The rear mounting ring 20 has a rear end, a front end, a positioning ring portion 21, and an outer thread 22. The front end of the rear mounting ring 20 is positioned toward the rear end of the front mounting ring 10. The positioning ring portion 21 axially protrudes from the rear end of the rear mounting ring 20. The outer thread 22 is formed around an outer sidewall of the positioning ring portion 21 and may engage with an inner thread formed around a front end of a lens of a camera, so as to mount the filter adaptor assembly on the lens of the camera.

The intermediate rings 30 are separately arranged between the front mounting ring 10 and the rear mounting ring 20. Each of the intermediate rings 30 has an annular shoulder 31, a front mounting ring portion 32, and a rear mounting ring portion 33. The annular shoulder 31 extends radially and has an outer peripheral edge and an inner peripheral edge. The front mounting ring portion 32 protrudes from the outer peripheral edge of the annular shoulder 31 toward the front mounting ring 10. The rear mounting ring portion 33 protrudes from the inner peripheral edge of the annular shoulder 31 toward the rear mounting ring 20 and has a connecting end edge and a distal end edge. The connecting end edge of the rear mounting ring portion 33 is attached to the inner peripheral edge of the annular shoulder 31.

Further, the front mounting ring portion 32 of the intermediate ring 30 that is disposed next to the front mounting ring 10 is mounted around an outer sidewall of the front mounting ring 10 and is detachably connected with the front mounting ring 10. A filter 60 may be selectively held between the limiting flange 12 of the front mounting ring 10 and the connecting end edge of the intermediate ring 30 that is disposed next to the front mounting ring 10. Grease may be applied between the front mounting ring 10 and the intermediate ring 30 that is disposed next to the front mounting ring 10, so as to eliminate friction therebetween.

In the preferred embodiment, the front mounting ring 10 and the front mounting ring portion 32 of the intermediate ring 30 that is disposed next to the front mounting ring 10 detachably engage with each other.

Specifically, the intermediate ring 30 has a first engaging protrusion 34 formed around an inner sidewall of the front mounting ring portion 32 of the intermediate ring 30. The front mounting ring 10 has a first engaging recess 13. The first engaging recess 13 is formed in and around the outer sidewall of the front mounting ring 10 and detachably engages with the first engaging protrusion 34 of the intermediate ring 30 that is disposed next to the front mounting ring 10. Thus, the front mounting ring 10 is detachably connected with the intermediate ring 30 that is disposed next to the front mounting ring 10.

The rear mounting ring 20 is mounted around an outer sidewall of the rear mounting ring portion 33 of the intermediate ring 30 that is disposed next to the rear mounting ring 20 and is detachably connected with the intermediate ring 30 that is disposed next to the rear mounting ring 20. Grease may be applied between the rear mounting ring 20 and the intermediate ring 30 that is disposed next to the rear mounting ring 20, so as to eliminate friction therebetween.

In the preferred embodiment, the rear mounting ring 20 and the rear mounting ring portion 33 of the intermediate ring 30 that is disposed next to the rear mounting ring 20 detachably engage with each other.

Specifically, the intermediate ring 30 has a second engaging recess 35 formed around the outer sidewall of the rear mounting ring portion 33 of the intermediate ring 30. The rear mounting ring 20 has a second engaging protrusion 23. The second engaging protrusion 23 is formed in and around an inner sidewall of the positioning ring portion 21 of the rear mounting ring 20 and detachably engages in the second engaging recess 35 of the intermediate ring 30 that is disposed next to the rear mounting ring 20. Thus, the rear mounting ring 20 is detachably connected with the intermediate ring 30 that is disposed next to the rear mounting ring 20.

Each of the at least one inner mounting ring 40 is mounted between two of the intermediate rings 30 that are disposed next to each other and has a front end, a rear end, and a stop flange 41. The front end of the inner mounting ring 40 is positioned toward the front mounting ring 10. The rear end of the inner mounting ring 40 is positioned toward the rear mounting ring 20. The stop flange 41 radially protrudes from and is formed around an inner sidewall of the inner mounting ring 40 and is disposed adjacent to the rear end of the inner mounting ring 40.

The front mounting ring portion 32 of the intermediate ring 30 that is disposed at the rear end of the inner mounting ring 40 is mounted around an outer sidewall of the inner mounting ring 40 and is detachably connected with the inner mounting ring 40. The rear mounting ring portion 33 of the intermediate ring 30 that is disposed at the front end of the inner mounting ring 40 is mounted around the inner sidewall of the inner mounting ring 40 and is detachably connected with the inner mounting ring 40. A filter 60 may be selectively held between the stop flange 41 of the inner mounting ring 40 and the connecting end edge of the rear mounting ring portion 33 of the intermediate ring 30 that is disposed at the rear end of the inner mounting ring 40. A filter 60 may be selectively held between the stop flange 41 of the inner mounting ring 40 and the distal end edge of the rear mounting ring portion 33 of the intermediate ring 30 that is disposed at the front end of the inner mounting ring 40. Grease may be applied between the inner mounting ring 40 and the intermediate rings 30, so as to eliminate friction therebetween.

In the preferred embodiment, each of the at least one inner mounting ring 40 is engaged with the front mounting ring portion 32 of the intermediate ring 30 that is disposed at the rear end of the inner mounting ring 40 and with the rear mounting ring portion 33 of the intermediate ring 30 that is disposed at the front end of the inner mounting ring 40.

Specifically, each of the at least one inner mounting ring 40 has a third engaging recess 42 and a third engaging protrusion 43. The third engaging recess 42 is formed in and around the outer sidewall of the inner mounting ring 40 and engages with the first engaging protrusion 34 of the intermediate ring 30 that is mounted at the rear end of the inner mounting ring 40. The third engaging protrusion 43 is formed around the inner sidewall of the inner mounting ring 40 and engages with the second engaging recess 35 of the intermediate ring 30 that is mounted at the front end of the inner mounting ring 40. Thus, each of the at least one inner mounting ring 40 is detachably connected with the intermediate rings 30.

As shown in FIG. 2, in the preferred embodiment, the filter adaptor assembly may include one front mounting ring 10, one rear mounting ring 20, two intermediate rings 30, and one inner mounting ring 40. The two intermediate rings 30 are respectively connected to the front mounting ring 10 and the rear mounting ring 20 and are connected to each other via the inner mounting ring 40. At most four filters 60 can be assembled in the filter adaptor assembly.

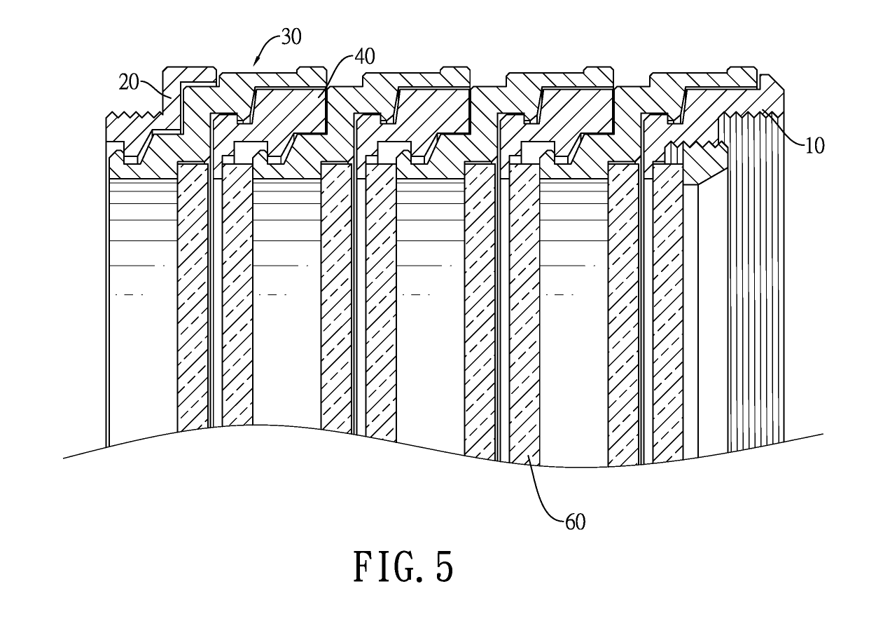

With further reference to FIG. 5, in another preferred embodiment, the filter adaptor assembly may include one front mounting ring 10, one rear mounting ring 20, four intermediate rings 30, and three inner mounting rings 40. The four intermediate rings 30 and the three inner mounting rings 40 are alternately arranged between the front mounting ring 10 and the rear mounting ring 20. At most eight filters 60 can be assembled in the filter adaptor assembly.

Moreover, the filter adaptor assembly may only include one front mounting ring 10, one rear mounting ring 20, and one intermediate ring 30. The front mounting ring 10 and the rear mounting ring 20 are connected to each other via the intermediate ring 30. At most two filters 60 can be assembled in the filter adaptor assembly.

That is, whenever one intermediate ring 30 and one inner mounting ring 40 are added, two more filters 60 can be assembled in the filter adaptor assembly.

The front mounting ring 10, the rear mounting ring 20, the intermediate rings 30, and the at least one inner mounting ring 40 may be made of metal, such as aluminum alloy, copper alloy, and the like. Resilience of the front mounting ring 10 at where the first engaging recess 13 is formed, resilience of the intermediate ring 30 at where the second engaging recess 35 is formed, and resilience of the inner mounting ring 40 at where the third engaging recess 42 is formed can be adjusted by adjusting thickness of the front mounting ring 10 at where the first engaging recess 13 is formed, thickness of the intermediate ring 30 at where the second engaging recess 35 is formed, and thickness of the inner mounting ring 40 at where the third engaging recess 42 is formed. Thus, the front mounting ring 10, the rear mounting ring 20, the intermediate rings 30, and the at least one inner mounting ring 40 can be engaged with each other with proper resilient force, so as to allow easy detachment and assembling.

The easily assembled filter adaptor assembly as described has the following advantages. Since the filters 60 are held between the front mounting ring 10, the rear mounting ring 20, the intermediate rings 30, and the at least one inner mounting ring 40, the filter adaptor assembly has a simplified and compact structure. Accordingly, volume of the filter adaptor assembly can be reduced. Furthermore, as the front mounting ring 10, the holding ring 50, the rear mounting ring 20, the intermediate rings 30, and the at least one inner mounting ring 40 are detachably connected to each other, numbers of the intermediate ring 30 and the inner mounting ring 40 can be increased or decreased so as to adjust numbers of the filters 60 that can be assembled in the filter adaptor assembly. Accordingly, users have high flexibility in using the filter adaptor assembly.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. An easily assembled filter adaptor assembly comprising:
a front mounting ring having
a rear end;
a connecting ring portion axially protruding from the rear end of the front mounting ring;
an inner sidewall defined inside and around the front mounting ring and having a sub inner sidewall, and the sub inner sidewall defined inside and around the connecting ring portion; and
a limiting flange radially protruding from and formed around the sub inner sidewall around the connecting ring portion;
a holding ring detachably mounted in the connecting ring portion of the front mounting ring, so as to selectively hold a filter between the holding ring and the connecting ring portion of the front mounting ring;
a rear mounting ring disposed at a rear of the front mounting ring and spaced apart from the front mounting ring, the rear mounting ring having a positioning ring portion, and the positioning ring portion axially protruding from a rear end of the rear mounting ring; and
an intermediate ring arranged between the front mounting ring and the rear mounting ring and having
an annular shoulder extending radially and having an outer peripheral edge and an inner peripheral edge;
a front mounting ring portion protruding from the outer peripheral edge of the annular shoulder toward the front mounting ring, mounted around an outer sidewall of the front mounting ring, and detachably connected with the front mounting ring; and
a rear mounting ring portion protruding from the inner peripheral edge of the annular shoulder toward the rear mounting ring and having a connecting end edge, and the connecting end edge of the rear mounting ring portion attached to the inner peripheral edge of the annular shoulder, so as to selectively hold a filter between the limiting flange of the front mounting ring and the connecting end edge of the intermediate ring;
wherein the rear mounting ring is mounted around an outer sidewall of the rear mounting ring portion of the intermediate ring and is detachably connected with the intermediate ring.

2. The filter adaptor assembly as claimed in claim 1, wherein
the front mounting ring and the front mounting ring portion of the intermediate ring detachably engage with each other; and
the rear mounting ring and the rear mounting ring portion of the intermediate ring detachably engage with each other.

3. The filter adaptor assembly as claimed in claim 2, wherein
the intermediate ring has a first engaging protrusion formed around an inner sidewall of the front mounting ring portion of the intermediate ring;
the front mounting ring has a first engaging recess, and the first engaging recess is formed in and around the outer sidewall of the front mounting ring and detachably engages with the first engaging protrusion of the intermediate ring;
the intermediate ring has a second engaging recess formed around the outer sidewall of the rear mounting ring portion of the intermediate ring; and
the rear mounting ring has a second engaging protrusion, and the second engaging protrusion is formed in and around an inner sidewall of the positioning ring portion of the rear mounting ring and detachably engages in the second engaging recess of the intermediate ring.

4. The filter adaptor assembly as claimed in claim 3, wherein
the front mounting ring has an inner thread formed around the inner sidewall of the front mounting ring;
the holding ring is connected to the connecting ring portion of the front mounting ring via the inner thread; and
the rear mounting ring has an outer thread formed around an outer sidewall of the positioning ring portion.

5. An easily assembled filter adaptor assembly comprising:
a front mounting ring having
a rear end;
a connecting ring portion axially protruding from the rear end of the front mounting ring;
an inner sidewall defined inside and around the front mounting ring and having a sub inner sidewall, and the sub inner sidewall defined inside and around the connecting ring portion; and
a limiting flange radially protruding from and formed around the sub inner sidewall around the connecting ring portion;
a holding ring detachably mounted in the connecting ring portion of the front mounting ring, so as to selectively hold a filter between the holding ring and the connecting ring portion of the front mounting ring;
a rear mounting ring disposed at a rear of the front mounting ring and spaced apart from the front mounting ring, the rear mounting ring having a positioning ring portion, and the positioning ring portion axially protruding from a rear end of the rear mounting ring;
multiple intermediate rings separately arranged between the front mounting ring and the rear mounting ring, and each of the intermediate rings having
an annular shoulder extending radially and having an outer peripheral edge and an inner peripheral edge;
a front mounting ring portion protruding from the outer peripheral edge of the annular shoulder toward the front mounting ring; and
a rear mounting ring portion protruding from the inner peripheral edge of the annular shoulder toward the rear mounting ring and having
a connecting end edge attached to the inner peripheral edge of the annular shoulder; and
a distal end edge; and
wherein the front mounting ring portion of the intermediate ring that is disposed next to the front mounting ring is mounted around an outer sidewall of the front mounting ring and is detachably connected with the front mounting ring, so as to selectively hold a filter between the limiting flange of the front mounting ring and the connecting end edge of the intermediate ring that is disposed next to the front mounting ring; and
the rear mounting ring is mounted around an outer sidewall of the rear mounting ring portion of the intermediate ring that is disposed next to the rear mounting ring and is detachably connected with the intermediate ring that is disposed next to the rear mounting ring;
at least one inner mounting ring, each of the at least one inner mounting ring is mounted between two of the intermediate rings that are disposed next to each other and has
a front end;
a rear end; and
a stop flange radially protruding from and formed around an inner sidewall of the inner mounting ring;
wherein the front mounting ring portion of the intermediate ring that is disposed at the rear end of the inner mounting ring is mounted around an outer sidewall of the inner mounting ring and is detachably connected with the inner mounting ring, so as to selectively hold a filter between the stop flange of the inner mounting ring and the connecting end edge of the rear mounting ring portion of the intermediate ring that is disposed at the rear end of the inner mounting ring;
the rear mounting ring portion of the intermediate ring that is disposed at the front end of the inner mounting ring is mounted around the inner sidewall of the inner mounting ring and is detachably connected with the inner mounting ring, so as to selectively hold a filter between the stop flange of the inner mounting ring and the distal end edge of the rear mounting ring portion of the intermediate ring that is disposed at the front end of the inner mounting ring.

6. The filter adaptor assembly as claimed in claim 5, wherein
the front mounting ring and the front mounting ring portion of the intermediate ring detachably engage with each other;
the rear mounting ring and the rear mounting ring portion of the intermediate ring detachably engage with each other; and
each of the at least one inner mounting ring is engaged with the front mounting ring portion of the intermediate ring that is disposed at the rear end of the inner mounting ring and with the rear mounting ring portion of the intermediate ring that is disposed at the front end of the inner mounting ring.

7. The filter adaptor assembly as claimed in claim 6, wherein
the intermediate ring has a first engaging protrusion formed around an inner sidewall of the front mounting ring portion of the intermediate ring;
the front mounting ring has a first engaging recess, and the first engaging recess is formed in and around the outer sidewall of the front mounting ring and detachably engages with the first engaging protrusion of the intermediate ring;
the intermediate ring has a second engaging recess formed around the outer sidewall of the rear mounting ring portion of the intermediate ring; and
the rear mounting ring has a second engaging protrusion, and the second engaging protrusion is formed in and around an inner sidewall of the positioning ring portion of the rear mounting ring and detachably engages in the second engaging recess of the intermediate ring;
each of the at least one inner mounting ring has
a third engaging recess formed in and around the outer sidewall of the inner mounting ring and engaging with the first engaging protrusion of the intermediate ring that is mounted at the rear end of the inner mounting ring; and
a third engaging protrusion formed around the inner sidewall of the inner mounting ring and engaging with the second engaging recess of the intermediate ring that is mounted at the front end of the inner mounting ring.

8. The filter adaptor assembly as claimed in claim 6, wherein
the front mounting ring has an inner thread formed around the inner sidewall of the front mounting ring;
the holding ring is connected to the connecting ring portion of the front mounting ring via the inner thread; and
the rear mounting ring has an outer thread formed around an outer sidewall of the positioning ring portion.
